(19) United States
(12) Patent Application Publication
(10) Pub. No.: US 2025/0194569 A1
(43) Pub. Date: Jun. 19, 2025

(54) FRAME WITH MAGNETIC PROPERTIES FOR A BEEHIVE

(71) Applicant: INRIMAGE, Grenoble (FR)

(72) Inventors: Xavier Pain, Grenoble (FR); Stéphane Wolozan, Echirolles (FR); Patrick Mathieux, La Buisse (FR); Jean-Paul Yonnet, Meylan (FR)

(21) Appl. No.: 18/847,780

(22) PCT Filed: Mar. 15, 2023
(86) PCT No.: PCT/EP2023/056560

§ 371 Date: Sep. 18, 2024

(30) Foreign Application Priority Data
Mar. 18, 2022 (FR) FR2202424

(51) Int. Cl. A01K 47/06

(52) U.S. Cl. CPC A01K 47/06

(57) ABSTRACT

A hive frame includes bars joined together and a central plate framed by the bars. This plate, which has two opposite sides, is made from a binder into which a magnetic powder has been added. The central plate is magnetized in a direction transverse to the two opposite sides.

### TECHNICAL FIELD OF THE INVENTION

The present invention relates to a frame usable in a beehive, the frame having magnetic properties.

### PRIOR ART

As known, a hive is composed mainly of a stand forming a bottom board from which bees take flight, surmounted by a first box forming the body of the hive and intended as a place for the bee colony to live, this body itself being surmounted by a super from which honey is intended to be collected. A queen excluder separates the body from the super, to prevent the queen from passing from the body to the super. The hive may comprise one or more supers fitted to the body. At the top, the hive comprises a roof, which closes the hive to protect it.

The body and each super are filled with frames that are inserted vertically and placed in parallel. Each frame comprises a plurality of bars and a central portion framed by the bars. The central portion may comprise a pre-honeycombed sheet of wax on which the bees may construct honeycomb, which is intended to receive pollen and honey. It has also been proposed for the central portion to take the form of a plate made of food-grade plastic, this plate being honeycombed directly. Patent application FR2940594A1 describes a central portion composed of an unapertured supporting plate, receiving on each of its two sides a honeycombed plate. Other solutions have of course been proposed. The patent U.S. Pat. No. 4,234,985 for its part describes production of a frame made of plastic.

To protect the bees present in the hive from insects and parasites, patent U.S. Pat. No. 5,162,014 proposes to create a magnetic field inside the hive, by placing permanent magnets on each frame inserted into the hive. The permanent magnets are added in the form of strips, each placed on a separate bar of the frame.

Patent application FR2972898 for its part proposes to apply a magnetic field to the interior of a hive by adding two magnets to two opposite sides of the body of the hive.

After technical study it has been found that magnetism can have a non-negligible influence on the health of bees, reducing their mortality rate, and on their productivity in terms of honey.

However, it turns out that the known magnetic solutions do not allow a uniform magnetic field to be obtained inside the hive. In patent application U.S. Pat. No. 5,162,014, the obtained magnetic field may be disturbed and is therefore ineffective, and in patent application FR2972898, it is not uniform inside the hive, because it is very strong around the magnets located outside the hive and very weak at the center of the hive.

The aim of the invention is therefore to provide a solution allowing magnetic induction to be obtained that is as uniform as possible inside the hive, whether in its body or in each super, and that has a good level of magnetic induction so as to optimize the reduction in the mortality rate of the bees and their productivity.

### SUMMARY OF THE INVENTION

This aim is achieved by a hive frame comprising a plurality of bars that are joined together and a central plate framed by said bars and having two opposite sides, the central plate being manufactured from a binder to which a magnetic powder is added and said central plate being magnetized in a direction transverse to its two opposite sides.

According to one particular aspect of the invention, the frame thus has a magnetization oriented perpendicularly to its plane of insertion into the body or into the super of the hive.

According to one particular embodiment, the magnetic powder is a strontium-ferrite powder or a barium-ferrite powder.

According to another particular embodiment, the magnetic powder is a neodymium-iron-boron powder.

The central plate takes the form of an element that is rigid and not very deformable.

According to one particularity, the binder is an elastomer, a thermoplastic polymer and/or a thermosetting polymer.

According to another particularity, the binder is food-grade polypropylene or food-grade polyamide.

According to one particularity, the binder is a textile such as natural cotton and/or cellulose coated with mineral products (pigments for example) mixed with stiffening products, such as paraffin for example.

According to another particularity, the two sides of the plate are honeycombed.

According to another particularity, the bars of the frame are made of plastic and/or wood.

According to another particularity, the bars of the frame are made of a magnetic plastic.

According to one particular embodiment, the frame takes the form of a one-piece element.

According to another particular embodiment, the plate takes the form of a one-piece element or is produced by joining a plurality of modules.

According to one particularity, the magnetic powder is added in a proportion of between 10% and 50% of the total volume.

The invention also relates to a hive comprising a body formed by an enclosure in which a plurality of frames is placed vertically, the frames being such as defined above.

According to one particular embodiment, the body comprises a plurality of lateral sides and a magnetic yoke formed by a plurality of panels each joined to one of its lateral sides.

The invention also relates to a hive comprising at least one super formed by an enclosure in which a plurality of frames is placed vertically, the frames being such as defined above.

According to one particular embodiment, the super comprises a plurality of lateral sides and a magnetic yoke formed by a plurality of panels each joined to one of its lateral sides.

### BRIEF DESCRIPTION OF THE FIGURES

Other features and advantages will become apparent in the following detailed description, which is given with reference to the appended drawings, in which:

FIG. 1 shows an exploded view of the architecture of a hive;

FIGS. 2A and 2B show a frame according to the invention, usable in a hive such as that of FIG. 1, seen in perspective and seen from the front, respectively;

FIG. 3 illustrates a principle of magnetization of a frame according to the invention;

FIGS. 4A and 4B show a view from above of a super of the hive, without a magnetic yoke and with a magnetic yoke, respectively.

### DETAILED DESCRIPTION OF AT LEAST ONE EMBODIMENT

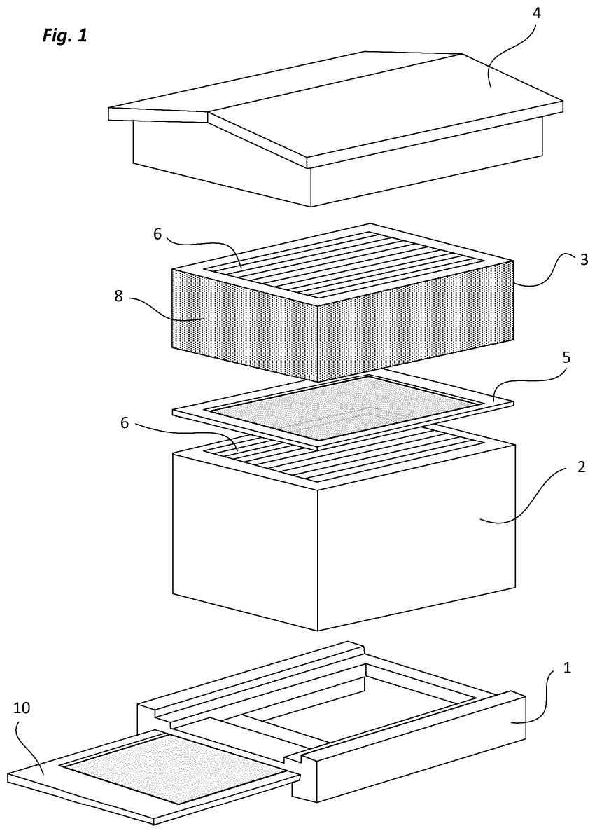

With reference to FIG. 1, as indicated above, a hive comprises a stand 1 comprising a bottom board 10. The stand 1 is surmounted by the body 2 of the hive, itself surmounted by one or more supers 3 (a single super in FIG. 1) and then by a roof 4. An excluder 5 may be placed between the body 2 and the first super 3 to prevent the queen from escaping.

In a known manner, the body 2 and each super 3 are filled with a plurality of frames 6 that are inserted vertically. Each frame 6 allows honey to be produced and stored.

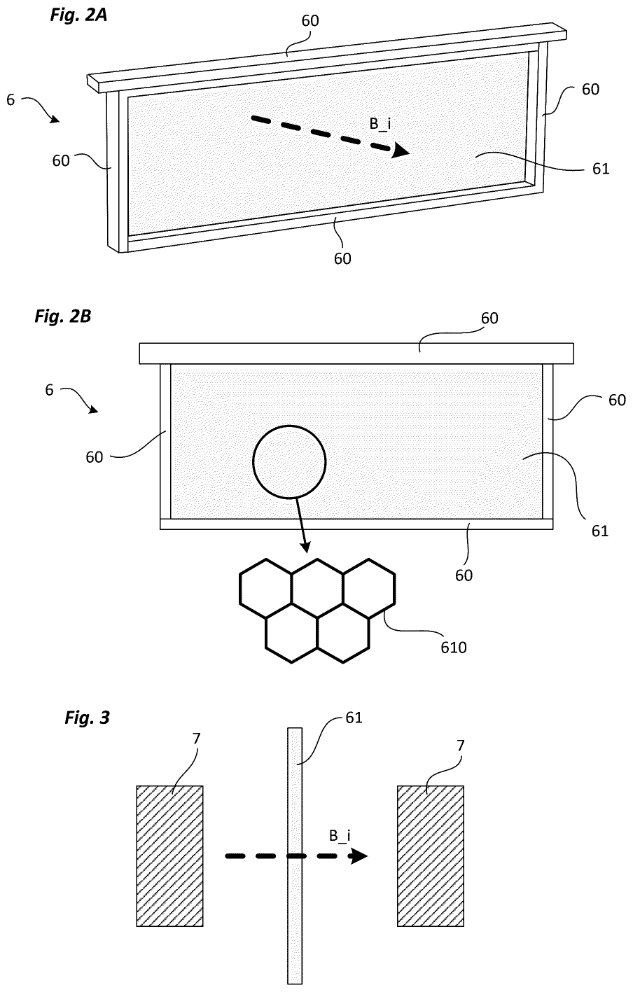

With reference to FIG. 2A and FIG. 2B, a frame 6 is rectangular in shape and comprises a plurality of bars 60 that are joined together in a rectangle, and a central portion 61 framed by the bars 60.

As a general rule, in the hive, each super 3 is intended for pollen and honey and the body 2 of the hive accommodates the bee brood.

According to the invention, the central portion of the frame 6 takes the form of a plate 61 having magnetic properties.

The plate 61 has two opposite sides.

To give it its magnetic properties, the plate is made of an elastomer or plastic that has magnetic properties (magnetic plastic sometimes also referred to as a plastic magnet) and that is obtained by mixing an elastomer binder, a thermoplastic- or thermosetting-polymer binder, with a magnetic powder. It is also possible to envision using a binder such as cellulose or natural cotton, i.e. a material that is more environmentally friendly than plastics. In the latter case, the deposit of cellulose or natural cotton is coated with mineral products (pigments) and optionally with stiffening materials such as paraffin in order to stiffen and rigidify the end product.

It would also be possible to use a mixture of a plurality of these binders.

The binder used is of food grade (it notably contains no bisphenol A (BPA)) and may be chosen from cellulose, cotton, an elastomer or a plastic. The elastomeric binder may for example be nitrile or EPDM (ethylene, propylene, diene monomer). The thermoplastic binder may for example be of polypropylene or polyamide type such as PA6, PA11 or PA12. Of course, other materials could be envisioned. The cellulose and cotton are advantageously bio-sourced.

The magnetic powder is for example chosen from a strontium-ferrite powder (preferred powder because it is stable and neutral), a barium-ferrite powder and a neodymium-iron-boron powder.

The powder is added to the binder in a proportion that may for example be of between 10% and 50% of the total volume (binder+powder). Ferrite particles are naturally flat. They may be re-oriented using a magnetic field during manufacture by injection molding in order to right the particles in the correct plane (they are then said to be anisotropic) or not (they are then isotropic—but the magnetic polarization will be 2 to 3 times less effective). The proportion of magnetic powder may notably be adjusted to obtain the desired level of magnetic polarization and a good level of magnetic induction between the frames, once the latter have been placed in the hive.

The plate 61 may comprise a simple foundation (optionally with a layer of wax) on which the bees may construct honeycomb, intended for the production of honey, or directly incorporate this comb 610 (FIG. 2B), which is then obtained directly during manufacture of the plate. The comb is then produced on both opposite sides of the plate 61. The comb does not pass right through the plate.

The plate 61 may for example be manufactured by injection molding or another equivalent solution. The first magnetization of the frame is advantageously carried out during injection molding but may be carried out subsequently, then optionally reiterated in case of demagnetization.

It will be noted that the plate 61 may take the form of a one-piece element (for example produced by injection molding) but may also be obtained by joining a plurality of unitary elements, these elements being magnetized before or after they are joined together to form the plate 61. Of course, other solutions could be envisioned for production of the plate 61. When the plate is intended to comprise comb, the unitary elements comprise this comb and joining them makes it possible to obtain the complete honeycombed plate.

With reference to FIG. 3, the magnetization may notably consist in placing the entire plate 61, the unitary elements or the entire frame 6 between two magnets 7, in order to polarize the particles of magnetic powder inside the plate and thus magnetize the plate 61 (magnetic induction B_i). Both magnets must be powerful and may be made of neodymium iron boron. Other magnetization solutions could be envisioned, such as use of electromagnetic coils for example. It will be noted that due to an unfavorable aspect ratio, it may be useful to re-magnetize each frame before its insertion into the hive, before each new period of production.

According to the invention, the plate 61 is magnetized so that its magnetic induction B_i is oriented perpendicular to its two sides and therefore passes right through the plate. It is thus oriented perpendicular to the plane of insertion of the frame 6 into the hive.

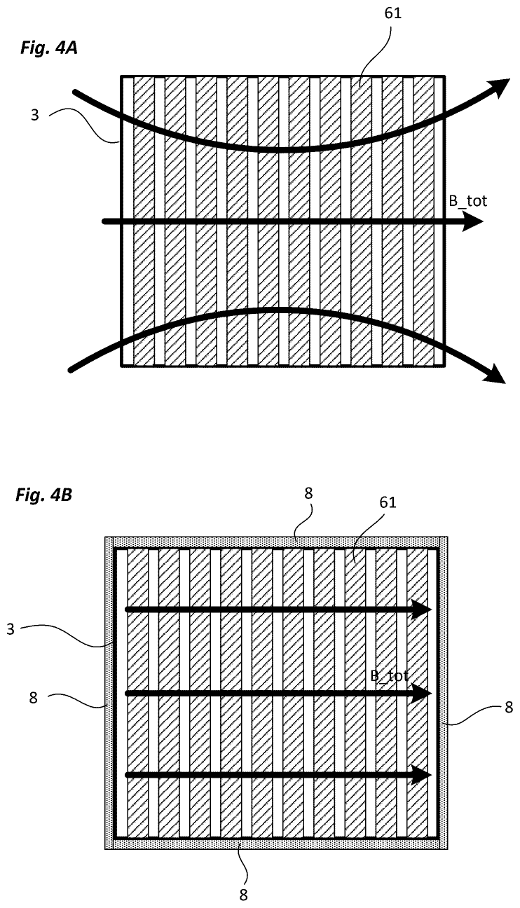

As illustrated in FIG. 4A, when a plurality of frames 6 of the type of the invention are juxtaposed in the body 2 and/or in each super 3 of the hive, the frames 6 are positioned so that their respective magnetic inductions B_i add, forming a total magnetic induction B_tot that passes right through the body 2 and/or each super 3 from side to side.

According to one particularity illustrated in FIG. 4B, in order to confine the magnetic induction within the body 2 and/or each super 3 of the hive, a magnetic yoke may be added to the hive. This yoke may be composed of a plurality of metal panels 8 fastened to the lateral external sides of the body 2 and/or super 3 of the hive (as in FIG. 4B), these panels 8 being joined together to close the yoke around the magnetic plates 61 present in the body 2. The panels 8 are for example dimensioned so as to completely cover the surface of each lateral side of the body 2 of the hive and, thus, to encircle it. The same principle may be applied to each new super 3 of the hive.

Advantageously, it is possible to imagine configuring the magnetic induction so that it changes from one story of the hive to another. By way of example, it could be advantageous to have a magnetic induction B_tot of 5 gauss through the body 2 and a stronger magnetic induction B_tot in the super 3, for example one equal to 50 gauss.

Non-limitingly, the plate 61 may have a thickness of between 1 mm and 12 mm, and for example of 1 to 3 mm when it belongs to a frame of the body 2 of the hive and of 10 mm when it belongs to a frame 6 intended for a super 3.

Non-limitingly, it is possible to use:
in the body 2, frames 6 each equipped with a plate made of smooth or honeycombed magnetic elastomer, having a thickness of between 1 and 3 mm and advantageously of 1.5 mm, optionally covered with a layer of wax, allowing the bees to build their habitat in their own way; these frames are not necessarily intended for the manufacture of honey and may have a lower level of magnetization than that given to super frames;
in each super 3, frames 6 each equipped with a plate made of magnetic plastic having a greater thickness (for example 10 mm) than that of the plates made of magnetic elastomer present in the frames of the body 2 of the hive; the plates of these frames are advantageously honeycombed on both sides and are intended for production of honey; the plates have a magnetization that may be ten times higher than that of the plates of the body 2 of the hive.

The bars 60 of the frame 6 may be made of wood or plastic. The plastic used may also be filled with magnetic powder, in the same proportions or in different proportions to that used for the central plate 61. In the latter case, the frame may take the form of a one-piece assembly, including the bars 60 and the central plate 61.

The frame 6 of the invention is compatible with the conventional tools employed to produce and extract honey (frame lifter, centrifuge, etc.). It may benefit from a marking on each bar 60 indicating the direction of magnetization, in order to facilitate installation in the hive and in conventional tools.

The solution of the invention thus has many advantages, among which:
it is based on conventional plastic sheets or films or frames, and has the same advantages, with the addition of magnetization;
it makes it possible to obtain a total magnetic field that on the whole is uniform inside the body and/or each super of the hive and a good level of magnetic induction;
it is compatible with existing hives, without modification;
it is compatible with the current solutions used to produce and extract honey;
it is easy to manufacture and install;
it may directly incorporate the comb used by bees to produce honey;
the magnetization may be usefully employed in the various tasks involved in removing honey and storing the frames.

1-17. (canceled)

18. An apparatus comprising a hive frame comprising a plurality of bars that have been joined together and a central plate that is framed by said bars, wherein said central plate comprises having two opposite sides, wherein said central plate is manufactured from a binder into which a magnetic powder has been added, and wherein said central plate is magnetized in a direction transverse to said two opposite sides.

19. The apparatus of claim 1, wherein said magnetic powder comprises strontium-ferrite powder or barium-ferrite powder.

20. The apparatus of claim 1, wherein said magnetic powder comprises neodymium-iron-boron powder.

21. The apparatus of one of claim 1, wherein said binder comprises an elastomer.

22. The apparatus of one of claim 1, wherein said binder is a thermoplastic or thermosetting polymer.

23. The apparatus of one of claim 1, wherein said binder comprises food-grade polypropylene.

24. The apparatus of one of claim 1, wherein said binder comprises food-grade polyamide.

25. The apparatus of one of claim 1, wherein said binder comprises a textile.

26. The apparatus of claim 1, wherein said binder comprises cellulose coated with mineral products mixed with stiffening products.

27. The apparatus of claim 1, wherein said two sides of said plate are honeycombed.

28. The apparatus of one of claim 1, wherein said bars comprise plastic.

29. The apparatus of claim 1, wherein said bars comprise wood.

30. The apparatus of claim 1, wherein said bars are made of a material and wherein said central plate is also made of said material.

31. The apparatus of claim 1, wherein said hive frame is a one-piece element.

32. The apparatus of claim 1, wherein said plate comprises plural modules that have been joined together.

33. The apparatus of claim 1, wherein said magnetic powder is added in a proportion of between 10% and 50% of a total volume of said binder.

34. The apparatus of claim 1, further comprising a hive that comprises a body formed by an enclosure and wherein said hive frame is one of a plurality of hive frames that are placed vertically in said enclosure.

35. The apparatus of claim 1, further comprising a hive having a body that comprises a plurality of lateral sides and a plurality of panels, each joined to one of said lateral sides, wherein said plurality of panels forms a magnetic yoke.

36. The apparatus of claim 1, further comprising a hive comprising a super formed by an enclosure, wherein said hive frame is one of a plurality of hive frames that are placed vertically in said enclosure.

37. The apparatus of claim 1, further comprising a hive that comprises at least one super that comprises a plurality of lateral sides and a magnetic yoke formed by a plurality of panels, each of said panels being joined to one of said lateral sides.
